(19) United States
(12) Patent Application Publication
(10) Pub. No.: US 2025/0102035 A1
(43) Pub. Date: Mar. 27, 2025

(54) Vibration Decoupling Sleeve, and Fastening Device Comprising a Vibration Decoupling Sleeve

(71) Applicant: Bayerische Motoren Werke Aktiengesellschaft, Muenchen (DE)

(72) Inventor: Andre DISCHER, Muenchen (DE)

(21) Appl. No.: 18/832,144

(22) PCT Filed: Feb. 14, 2023
(86) PCT No.: PCT/EP2023/053602

§ 371 Date: Jul. 23, 2024

(30) Foreign Application Priority Data
Mar. 24, 2022 (DE) 10 2022 106 955.9

(51) Int. Cl. F16F 1/373; F16B 43/00; F16F 1/376

(52) U.S. Cl. CPC F16F 1/3732; F16B 43/00; F16F 1/376; F16F 2230/0023

(57) ABSTRACT

A vibration decoupling sleeve comprising: axial end sides that face in opposite directions; a central opening which is defined by a radial inner side; an outer side which delimits the vibration decoupling sleeve on the outside; and, a peripheral receiving groove on the outer side, which groove is delimited by two opposing axial groove-delimiting sides and a groove bottom, wherein the groove-delimiting sides, the radial inner side and the axial end sides define abutments against a mounting part on the one hand and, on the other hand, against a component which is to be decoupled from the mounting part in terms of vibration and is to be fastened to the mounting part. The vibration decoupling sleeve comprises a sleeve-shaped core portion made of an elastomeric material from which one or more projections project in order to form at least one of the abutments.

### BACKGROUND AND SUMMARY

The disclosure relates to a vibration-decoupling sleeve having: i) axial end sides which are oriented in opposite directions; ii) a central opening which is defined by a radial inner side; iii) an outer side which delimits the vibration-decoupling sleeve externally; and, iv) an encircling receiving groove on the outer side, which groove is delimited by two oppositely situated axial groove-delimitation sides and a groove base, wherein the groove-delimitation sides, the radial inner side and the axial end sides define abutments against a holding part, on the one hand, and against a structural part to be fastened to the holding part that is to be decoupled in terms of vibration from the holding part, on the other hand. The disclosure furthermore relates to a fastening device for fastening a structural part, in particular a vehicle display, to a holding part, in particular to a vehicle structure, having such a vibration-decoupling sleeve.

Vibration-decoupling sleeves serve, in the case of vehicles, in particular motorcycles, but also in the case of passenger motor vehicles and trucks, for protecting add-on parts attached to the vehicle structure against vibrations. FIG. 1 shows such a vibration-decoupling sleeve 1, composed of an elastomer material, according to the prior art. The vibration-decoupling sleeve 1 has a central opening 2 in which a cylindrical fastening bolt can be received, and has two axial end sides 3, 4 which are oriented in opposite directions. Provision is made in an outer side 5 of an encircling receiving groove 6 which is delimited by two oppositely situated axial groove-delimitation sides 7 and by a groove base 8. The vibration-decoupling sleeve 1 is inserted into a cutout of the vehicle structure by way of the receiving groove 6, wherein the vehicle structure ideally projects into the receiving groove 6 as far as the groove base 8. Attached to the structural part to be fastened is the fastening bolt, which projects through the central opening 2 and is fixed, for example with the aid of a latching ring, on that end side 3 of the vibration-decoupling sleeve 1 which is opposite the structural part.

A problem in this case is that, during the operation of a vehicle, different types of vibrations occur. In this regard, the drive of the vehicle normally induces vibrations with a relatively high frequency in the region of approximately 1 kHz and with a small amplitude both in a radial direction and in an axial direction, while, on account of the road condition, there tend to occur low-frequency vibrations which, however, have large amplitudes.

For effective decoupling of the engine vibrations with a small amplitude, the vibration-decoupling sleeve 1 should have as low a stiffness as possible, that is to say consist of as soft a material as possible. By contrast, for the decoupling of the excitations with a large amplitude induced by the roadway, as high a stiffness as possible for the vibration-decoupling sleeve 1 is necessary. Moreover, as great a Shore hardness as possible for the material used allows the service life to be extended, too.

Consequently, the known vibration-decoupling sleeve 1 can be optimized at best for one type of vibration, and for this reason damage can occur both to the vibration-decoupling sleeve 1 and to the structural part attached to the vehicle. Moreover, on account of tolerances of the structure receiving the sleeve and of the further components, it is commonly the case that an ideal fit of the vibration-decoupling sleeve is not provided, so that this is unable to realize its optimum effect.

It is therefore an object of the disclosure to provide a vibration-decoupling sleeve, or a fastening device, with which the problems known from the prior art are avoided.

According to a first aspect of the disclosure, provision is made for this purpose of a vibration-decoupling sleeve of the type mentioned in the introduction, wherein the vibration-decoupling sleeve comprises a sleeve-shaped core section composed of an elastomer material, from which sleeve-shaped core section, for forming at least one of the abutments, there protrude one or more projections which, when viewed in an axial section, narrow towards their end furthest away from the core section and which transition in one piece into the core section.

As a result of the narrowing projections, in the installation state, the respective abutments have a contact surface area which is reduced in comparison with the prior art. Thus, for vibrations with a small amplitude, which occur on account of engine vibrations and have a relatively high frequency of approximately 1 kHz, the vibration-decoupling sleeve according to the disclosure has low stiffness since here compression is realized only (and in part) by the narrowing projections and thus little of the elastomer material.

If (additionally) there occur vibrations with a large amplitude, which arise due to roadway excitation, for example on account of unevennesses or potholes, then the vibration-decoupling sleeve, for decoupling these large-amplitude vibrations, provides relatively high stiffness since, on account of the enlargement of the cross section of the projections in the direction of the core section, with increasing vibration amplitude, more and more material has to be compressed.

Consequently, as a result of the geometrical configuration of the vibration-decoupling sleeve according to the disclosure, with uniform Shore hardness of the elastomer material used, amplitude-dependent stiffness is achieved. Thus, both vibrations with a small amplitude induced by the drive of the vehicle and vibrations with a relatively large amplitude occurring due to roadway excitation can be optimally decoupled, and damage to the vehicle components and to the vibration-decoupling sleeve itself are avoided.

Furthermore, with the vibration-decoupling sleeve according to the disclosure, it is possible to select an elastomer material with a greater Shore hardness than was the case in the prior art, since the geometrical configuration with the narrowing projections provides for the required low stiffness in relation to vibrations of relatively high frequency with a small amplitude. This has a positive effect on the service life of the vibration-decoupling sleeve.

Beside the already mentioned applications in vehicles of all types, the vibration-decoupling sleeve according to the disclosure can also be advantageously used in other areas in which components are to be protected against vibrations, for example in the case of wind turbines or the like.

Preferably, at least one of the abutments is formed by an annular projection which runs around annularly in a closed manner. This results in a configuration which is simple to produce and by way of which the desired staggering of the stiffness according to the amplitude of the vibrations that occur is achieved.

In a preferred embodiment, at least one of the abutments is formed by multiple circumferentially spaced-apart projections, in particular projections of a crenellated design, wherein the projections are situated along an imaginary circular ring. The configuration with multiple circumferentially spaced-apart projections allows the stiffness to be set with even greater precision.

In particular, it is possible here to adapt both the height of the projections and the width of the projections in the circumferential direction to the corresponding usage situation in a precise manner. Through variation of the height of the projections, the transition point of the low-stiffness range to the high-stiffness range can be set as desired, and, through variation of the width of the individual projections, which are of a crenellated design, the value of the stiffness can be influenced in the low-stiffness range.

It is of course possible for in particular a plurality of the abutments to be formed by multiple circumferentially spaced-apart projections, for example at one of the axial end sides and at least one axial groove-delimitation side. Advantageously, both an abutment for the structural part to be fastened and an abutment for the holding part are formed by multiple circumferentially spaced-apart projections. In this way, optimal vibration decoupling in an axial direction is realized at both components.

According to a preferred embodiment, the abutment at one axial end side, in particular at the end side which abuts against the structural part to be fastened, is in the form of an in particular closed, annularly encircling projection. According to a preferred embodiment, the projection is directly or approximately directly adjacent to the central opening. In other words, according to a preferred embodiment, the annular projection has a diameter which is smaller or significantly smaller than the diameter of the vibration-decoupling sleeve. This advantageously allows the abutment or contact surface area, or the diameter thereof, to be reduced, whereby the vibration-decoupling sleeve is suitable for use in the case of relatively small installation spaces, too. The abutment may also comprise a multiplicity of projections which are arranged—according to the smaller diameter—in an annular manner.

In one refinement of the disclosure, the radial inner side has multiple narrowing projections which are spaced apart from one another axially and which are each situated on an imaginary circular ring. In this configuration, the vibration-decoupling sleeve, in the rest state, abuts against a normally cylindrical fastening bolt only by way of the projections, said fastening bolt fastening the structural part to the holding part, and thus provides in a radial direction, too, stiffness adapted to the respective amplitude of the different types of vibration occurring during operation, that is to say low stiffness for vibrations of relatively high frequency with a small amplitude, which are induced by the engine, and relatively high stiffness for low-frequency vibrations with a large amplitude, which occur for example on account of the road condition.

In a preferred embodiment, provision is made of one or more narrowing projections on an, in particular a single, axial end side. Said end side then forms for example an abutment against the holding part or the structural part to be fastened.

In particular, provision is made here of multiple narrowing projections which are formed so as to be spaced apart circumferentially and which are situated along an imaginary circular ring.

In a particularly advantageous configuration, the vibration-decoupling sleeve comprises a base part composed of elastomer material, which base part comprises the core section and the narrowing projections and also a protective disk, wherein the protective disk consists of a material harder than that of the base part and is fastened to an axial end face of the base part. The protective disk is in this case connected fixedly to the base part, for example adhesively bonded into it or vulcanized into the elastomer material, and serves for protecting the surface of the vibration-decoupling sleeve, for example against damage by a metallic fastening element that is arranged in this region.

Preferably, provision is made at least on one, in particular on both axial groove- delimitation sides of one or more narrowing projections which extend axially in the direction of the oppositely situated groove-delimitation side. The groove serves in this case for receiving the holding part or the structural part in that, in the holding part or in the structural part, provision is made of a preferably circular opening into which the vibration-decoupling sleeve is inserted and, as it were, latched. By way of the narrowing projections, in this contact region, there is provided stiffness of the vibration-decoupling sleeve that is adapted to the respective amplitude of the vibrations that occur.

In a particularly preferred embodiment, one axial groove-delimitation side has multiple projections extending along an imaginary ring and the other groove-delimitation side has a circumferentially encircling annular projection. Such a configuration has been found to be particularly favorable.

Moreover, as a result of the projections on both axial groove-delimitation sides situated opposite one another, an advantageous geometry is formed in the transition region from a respective groove-delimitation side to the groove base, in the case of which advantageous geometry the “edge”, when viewed in an axial section, is formed not by a right angle but by a radius of part of a circle. In this configuration, in the case of sharp edges of the component received in the groove (that is to say the structural part or the holding part), no damage occurs to the vibration-decoupling sleeve or significantly less damage occurs thereto than was the case with the vibration-decoupling sleeve known from the prior art with a right-angled abutment edge.

Particularly good adaptability of the stiffness to different amplitudes of the vibrations that occur can be achieved in that the projections have a rounded free end and/or a triangular or trapezoidal cross section, when viewed in an axial cross section.

According to a second aspect of the disclosure, provision is made of a fastening device for fastening a structural part, in particular a vehicle display, to a holding part, in particular to a vehicle structure. The fastening device has a vibration-decoupling sleeve as has been described above, has a cylindrical fastening bolt which projects into the opening of the vibration-decoupling sleeve and which is clamped therein, has a C-shaped, split latching ring that is partially received in a groove on the cylindrical fastening bolt and that presses against one axial end side of the vibration-decoupling sleeve, and has a respective supporting surface on the structural part and on the holding part, wherein one supporting surface presses against the other axial end side of the vibration-decoupling sleeve and the other supporting surface presses against a groove-delimitation side, in particular wherein the projection(s) is/are preloaded and partially compressed.

In the context of the disclosure, “partially compressed” is to be understood as meaning that the projections are still present or are recognizable as such. On account of the preloading of the projections, which, in particular in the rest state, prevails both in the axial direction and in the radial direction, an ideal form-fitting fit of the vibration-decoupling sleeve, and thus the full effectiveness thereof, is ensured within the defined tolerances of the receiving structure.

Preferably, in this case, the cylindrical fastening bolt is formed in one piece with the structural part and is pushed into the central opening of the vibration-decoupling sleeve, which in turn is inserted into a circular opening in the holding part, the edge of which circular opening projects into the groove in the outer side of the vibration-decoupling sleeve such that one or both groove-delimitation sides are supported against the holding part.

The split latching ring is provided at that end of the fastening bolt which is at a distance from the component, said split latching ring pressing against that axial end side of the vibration-decoupling sleeve to which the protective disk composed of relatively hard material is fastened. The other axial end side of the vibration-decoupling sleeve is supported against the component.

Furthermore, all the refinements and advantages that have been described with regard to the vibration-decoupling sleeve according to the disclosure, also apply to the fastening device according to the disclosure, and vice versa.

### BRIEF DESCRIPTION OF THE DRAWINGS

Further features and advantages emerge from the following description of a preferred embodiment on the basis of the appended drawings.

FIG. 1 shows a perspective view of a vibration-decoupling sleeve according to the prior art;

FIG. 2 shows a perspective view of a vibration-decoupling sleeve according to the disclosure;

FIG. 3 shows a perspective sectional view of the vibration-decoupling sleeve from FIG. 2;

FIG. 4 shows an axial section through the vibration-decoupling sleeve in FIGS. 2 and 3;

FIG. 5 shows a plan view of one axial end side of the vibration-decoupling sleeve in FIGS. 2 to 4;

FIG. 6 shows a plan view of the other axial end side of the vibration- decoupling sleeve in FIGS. 2 to 5; and,

FIG. 7 shows a perspective view, partly in section, of a fastening device according to the disclosure, in which the vibration-decoupling sleeve in FIGS. 2 to 6 is used.

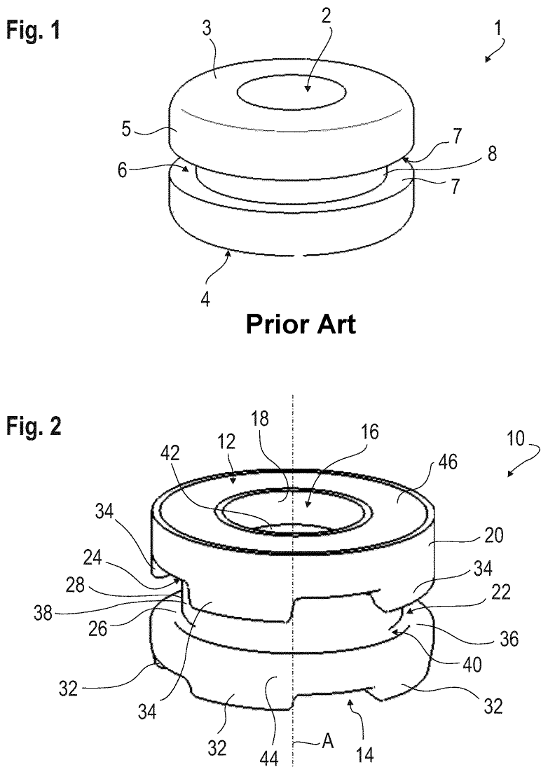

### DETAILED DESCRIPTION OF THE DRAWINGS

FIGS. 2 to 6 show a vibration-decoupling sleeve 10 according to the disclosure, which is used in a fastening device by way of which a structural part, in particular a vehicle display, is fixed to a holding part, in particular to a vehicle structure.

The vibration-decoupling sleeve 10 has two axial end sides 12, 14 which are oriented in opposite directions, and has a central opening 16 which is defined by a radial inner side 18.

The vibration-decoupling sleeve 10 furthermore has an outer side 20 which delimits said sleeve externally and on which an encircling receiving groove 22 is provided. The receiving groove 22 is delimited by two oppositely situated axial groove-delimitation sides 24, 26 and a groove base 28.

The groove-delimitation sides 24, 26, the radial inner side 18 and the axial end sides 12, 14 define abutments against the holding part and against the structural part to be fastened to the holding part, wherein, when fastened, the structural part is to be decoupled in terms of vibration from the holding part.

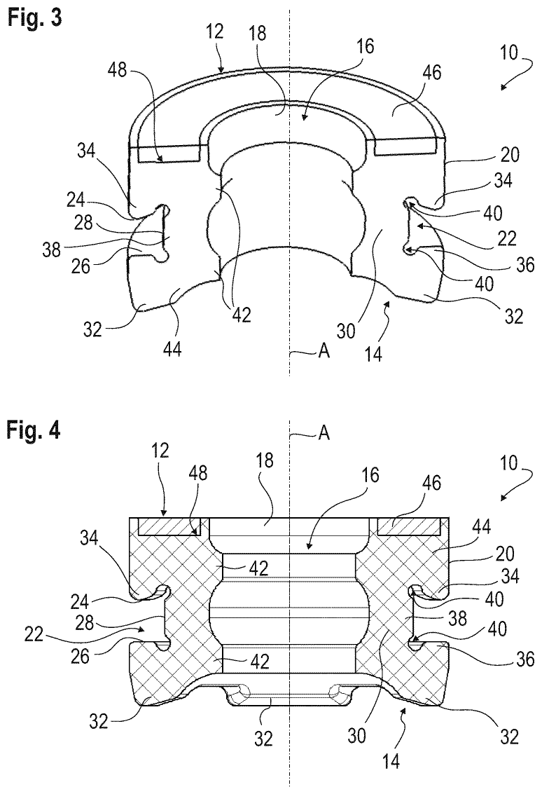

For this purpose, the vibration-decoupling sleeve 10 comprises a sleeve-shaped core section 30 composed of an elastomer material (see in particular FIGS. 3 and 4), wherein protruding from the sleeve-shaped core section 30 are multiple projections 32, 34, 36, 38, 42 which transition in one piece into the core section 30 and which, when viewed in an axial section, each narrow towards their end furthest away from the core section 30.

In this case, provision is made of a first group of multiple, here four, narrowing projections 32 on the axial end side 14, wherein the projections 32 are spaced apart from one another circumferentially and are of a crenellated design. The projections 32 are situated in a uniformly distributed manner along an imaginary circular ring, as can be seen in particular from FIG. 6.

The projections 32, when viewed in an axial section, have a substantially triangular or trapezoidal cross section and have rounded free ends. In plan view in an axial direction A, too, said projections are trapezoidal with rounded corners (see FIG. 6).

Provision is made of a second group of narrowing projections 34 on the upper axial groove-delimitation side 24 in FIGS. 2 to 4. These projections 34, too, are situated along an imaginary circular ring and are spaced apart from one another circumferentially and are of a crenellated design. In turn, provision is made of four projections 34 which are identical in terms of their geometrical shape to the projections 32 and which are provided at the same positions as the latter in a circumferential direction U. Alternatively, the projections 32 and 34 could also be arranged in an offset manner in the circumferential direction U.

It should be noted that, instead of the configuration shown here with in each case four projections 32, 34 of a crenellated design that extend in the circumferential direction U, in each case over an angle range of approximately 45° of the imaginary circular ring, more or fewer projections 32, 34 may also be provided. It is likewise conceivable for provision to be made here of in each case one single closed, annularly encircling projection 32, 34.

The lower groove-delimitation side 26 in FIGS. 2 to 4 has a single circumferentially encircling annular projection 36, wherein both the projections 34 and the projection 36 extend in the axial direction A to the in each case oppositely situated groove-delimitation side 26 or 24. The projection 36, too, has, when viewed in an axial section, a substantially trapezoidal cross section and rounded free ends.

Moreover, the groove base 28 has a projection 38 which narrows towards the outer side 20 of the vibration-decoupling sleeve 10 and which is of substantially annular form and which runs around annularly in a closed manner.

Consequently, in the regions in which in each case one axial groove-delimitation side 24 or 26 and the groove base 28 meet one another or transition into one another, there are formed annular recesses 40 which run circumferentially around the vibration-decoupling sleeve 10 and, in an axial section (FIGS. 3 and 4), are delimited by a three-quarter circle line.

As can be seen in particular from the sectional views in FIGS. 3 and 4, it is moreover the case that the radial inner side 18 has multiple, here two, narrowing projections 42 which are spaced apart from one another axially and which are each situated on an imaginary circular ring. The projections 42, when viewed in an axial section, have a substantially trapezoidal cross section.

Since the associated fastening bolt has a substantially circular-cylindrical shape, only the projections 42 abut against the fastening bolt in the installation state, which, for vibrations of a relatively high frequency with a small amplitude, as are induced by the drive of the vehicle, gives rise to low stiffness of the vibration-decoupling sleeve 10 in a radial direction, too.

The height of the projections 32, 34, 36, 38, 42 is in each case at most 1 mm, preferably approximately 0.8 mm.

The sleeve-shaped core section 30 and the narrowing projections 32, 34, 36, 38, 42 formed in one piece thereon together form a solidly designed base part 44 composed of elastomer material.

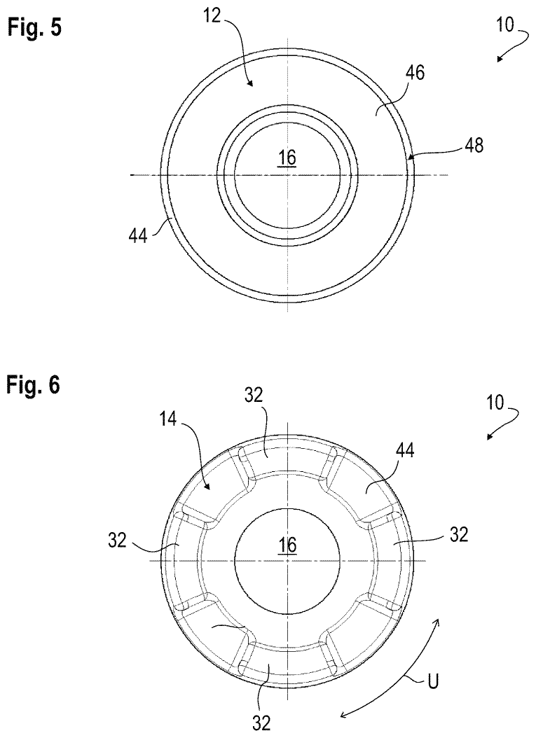

In the region of the upper axial end side 12 in FIGS. 2 to 4, a protective disk 46 is fastened to an axial end face 48 of the base part 44 and consists of a material which is harder than the material of the base part 44. Here, use is made for example of aluminum or a plastic with a greater Shore hardness than the base part 44. The protective disk 46 may be adhesively bonded to the base part 44 or vulcanized into the material of the base part 44 (see in particular FIG. 5).

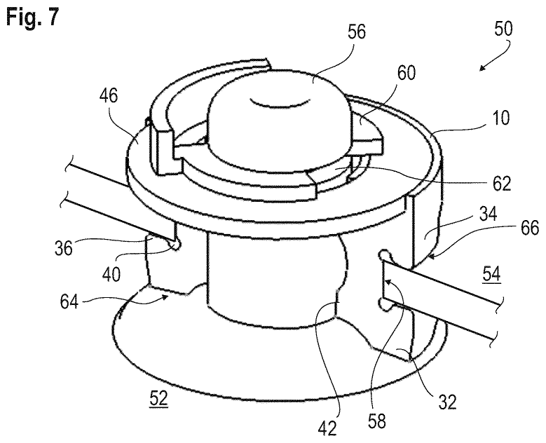

FIG. 7 shows the use of the vibration-decoupling sleeve 10 in a fastening device 50. This serves for fastening a structural part 52, here a vehicle display for a motorcycle, to a holding part 54 (indicated merely schematically in FIG. 7), here a vehicle structure.

In this case, the structural part 52 and the holding part 54 are to be decoupled in terms of vibration from one another so as to prevent damage to the structural part 52 on account of extensive coupling-in of vibrations, occurring as a result of engine vibrations, on the one hand, and vibrations induced in a manner specific to the roadway, on the other hand.

The fastening device 50 has a cylindrical fastening bolt 56 which is formed in one piece on the structural part 52. It is alternatively also possible for the fastening bolt 56 to be designed as a separate structural part.

For vibration-decoupled fixing of the structural part 52 to the holding part 54, the vibration-decoupling sleeve 10 is inserted into a circular opening 58 of the holding part 54 in such a way that that region of the plate-like holding part 54 which surrounds the opening 58 projects into the receiving groove 22 on the outer side 20 of the vibration-decoupling sleeve 10.

The cylindrical fastening bolt 56 is pushed into the central opening 16 of the vibration-decoupling sleeve 10 and clamped therein.

For securing the fastening bolt 56, provision is made of a C-shaped, split latching ring 60 composed of metal that is partially received in a groove 62 which is situated on that end of the fastening bolt 56 furthest away from the structural part 52. Moreover, the split latching ring 60 presses against that axial end side 12 of the vibration-decoupling sleeve 10 on which the protective disk 46 is arranged.

Since the latching ring 60 can be sharp-edged, the protective disk 46, composed of a relatively hard material, ensures in this case that the elastomer material of the vibration-decoupling sleeve 10 is not damaged in the case of deformations or vibrations occurring during operation, particularly if the latching ring 60 does not abut on the axial end side 12 in a completely planar manner, but is slightly inclined in relation thereto.

The other axial end side 14 of the vibration-decoupling sleeve 10, which has the narrowing projections 32, presses against a supporting surface 64 formed on the structural part 52, while the projections 34 of the groove-delimitation side 24 press against a supporting surface 66 on the holding part 54.

According to one embodiment, the abutment at the end side 14 is in the form of an in particular closed, annularly encircling projection (not shown here) which directly adjoins or is directly adjacent to the central opening 30. The diameter is thus advantageously significantly smaller than the diameter of the base part 44, whereby the contact or abutment surface area can be advantageously reduced. This is particularly advantageous if, for example, the bearing surface 64 is very small. The abutment may also be formed by a multiplicity of projections which are arranged according to the smaller diameter.

In the installation state shown in FIG. 7, all the narrowing projections 32, 34, 36, 38, 42 are preloaded and partially compressed, whereby optimal action of the vibration-decoupling sleeve 10 is ensured virtually independently of tolerances of the components connected to one another. Here, undesired play is prevented in an effective manner.

During the operation of the vehicle, when use is made of the fastening device 50 with the vibration-decoupling sleeve 10, vibrations occur, wherein, by way of the drive of the vehicle, vibrations with a relatively high frequency in the region of approximately 1 kHz but a small amplitude of a few tenths of a millimeter are induced, on the one hand, and, on account of the road condition, vibrations with a relatively low frequency but a relatively high amplitude occur, on the other hand.

In this case, the vibration-decoupling sleeve 10 provides for reliable decoupling of the structural part 52 and the holding part 54 and, in this way, prevents damage to the structural part 52.

By contrast to the vibration-decoupling sleeves 1 known from the prior art, in the case of which all the abutment surfaces are of full-area form, the vibration-decoupling sleeve 10 according to the disclosure, on account of the narrowing projections 32, 34, 36, 38, 42, abuts in the installation state only with relatively small abutment surfaces against all the components involved.

Thus, both in the axial direction (via the projections 32, 34 and 36) and in the radial direction (projections 42), the vibration-decoupling sleeve 10 has low stiffness for vibrations with a small amplitude, as are induced by the vehicle drive, and can act in an optimally vibration-decoupling manner in this range.

If, however, on account of the road condition, low-frequency vibrations with a large amplitude (additionally) occur, then the projections 32, 34, 36, 38, 42 are in a state compressed, or are compressed, to a great extent both in the axial direction and in the radial direction, and for this reason the vibration-decoupling sleeve 10 resists said vibrations with relatively high stiffness.

Thus, with uniform Shore hardness of the elastomer material of the base part 44, both vibrations with a small amplitude and vibrations with a relatively large amplitude can be optimally decoupled using the vibration-decoupling sleeve 10 according to the disclosure.

On account of the configuration of the receiving groove 22 with the circular recesses 40, which constitute an optimized corner geometry, it is moreover ensured that, in the case of a sharp-edged design of the holding part 54, in the region of the opening 58, under the vibration-induced deformations occurring during operation, damage to the vibration-decoupling sleeve 10 in said region, as occurred with previous vibration-decoupling sleeves having a straight edge, is avoided.

In addition, in the case of the vibration-decoupling sleeve 10 according to the disclosure, it is possible for different stiffnesses to be achieved by way of dimensions of the projections 32, 34, 36, 38, 42 that are adapted to the respective usage situation.

Through variation of the height of the projections 32, 34, 36, 38, 42, the transition point from the low-stiffness range to the high-stiffness range can be set as desired.

Through variation of the width of the individual projections 32, 34, which are of a crenellated design, the size of the stiffness can be influenced in the low-stiffness range.

The vibration-decoupling sleeve 10 according to the disclosure allows both coupling-in of vibrations of a relatively high frequency with a small amplitude and coupling-in of vibrations of low frequency with a relatively large amplitude to be reduced or compensated. In this case, the base part 44 of the vibration-decoupling sleeve 10 has a uniform Shore hardness which, moreover, for achieving a long service life, can be configured to be as high as possible. It is nevertheless ensured by the narrowing projections 32, 34, 36, 38, 42 that the vibration-decoupling sleeve 10 has sufficiently low stiffness for coupling-in of vibrations of relatively high frequency on account of the vehicle drive.

1.-10. (canceled)

11. A vibration-decoupling sleeve comprising:
axial end sides which are oriented in opposite directions,
a central opening which is defined by a radial inner side,
an outer side which delimits the vibration-decoupling sleeve externally, and
an encircling receiving groove on the outer side, which groove is delimited by two oppositely situated axial groove-delimitation sides and a groove base,
wherein the groove-delimitation sides, the radial inner side and the axial end sides define abutments against a holding part, on the one hand, and against a structural part to be fastened to the holding part that is to be decoupled in terms of vibration from the holding part, on the other hand,
wherein the vibration-decoupling sleeve comprises a sleeve-shaped core section composed of an elastomer material, from which sleeve-shaped core section, for forming at least one of the abutments, there protrude one or more projections which, when viewed in an axial section, narrow towards their end furthest away from the core section and which transition in one piece into the core section.

12. The vibration-decoupling sleeve according to claim 11, wherein at least one of the abutments is formed by an annular projection which runs around annularly in a closed manner.

13. The vibration-decoupling sleeve according to claim 11, wherein at least one of the abutments is formed by multiple circumferentially spaced-apart projections, wherein the projections are situated along an imaginary circular ring.

14. The vibration-decoupling sleeve according to claim 11, wherein the radial inner side has multiple narrowing projections which are spaced apart from one another axially and which are each situated on an imaginary circular ring.

15. The vibration-decoupling sleeve according to claim 11, wherein provision is made of one or more narrowing projections on an axial end side.

16. The vibration-decoupling sleeve according to claim 11, wherein the vibration-decoupling sleeve comprises a base part composed of elastomer material, which base part comprises the core section and the narrowing projections and also a protective disk, wherein the protective disk consists of a material harder than that of the base part and is fastened to an axial end face of the base part.

17. The vibration-decoupling sleeve according to claim 11, wherein provision is made at least on one axial groove-delimitation sides of one or more narrowing projections which extend axially in the direction of the oppositely situated groove-delimitation side.

18. The vibration-decoupling sleeve according to claim 17, wherein one axial groove-delimitation side has multiple projections extending along an imaginary ring and the other groove-delimitation side has a circumferentially encircling annular projection.

19. The vibration-decoupling sleeve according to claim 11, wherein the projections have a rounded free end and/or a triangular or trapezoidal cross section, when viewed in an axial cross section.

20. A fastening device for fastening a structural part to a holding part comprising:
a vibration-decoupling sleeve according to claim 11,
a cylindrical fastening bolt which projects into the opening of the vibration-decoupling sleeve and is clamped therein,
a C-shaped, split latching ring that is partially received in a groove on the cylindrical fastening bolt and presses against one axial end side of the vibration-decoupling sleeve, and
a respective supporting surface on the structural part and on the holding part,
wherein one supporting surface presses against the other axial end side of the vibration-decoupling sleeve and the other supporting surface presses against a groove-delimitation side.

21. The fastening device for fastening a structural part to a holding part of claim 20, wherein the projection(s) is/are preloaded and partially compressed.
